(19) United States
(12) Patent Application Publication
(10) Pub. No.: US 2007/0021990 A1
(43) Pub. Date: Jan. 25, 2007

(54) Ticket booking system and method of determining an arrival airport according to a phone number

(75) Inventors: Ronald Lee, Sindian City (TW); Gino Li, Sindian City (TW)

Correspondence Address: BACON & THOMAS, PLLC, 625 SLATERS LANE, FOURTH FLOOR, ALEXANDRIA, VA, 22314, US

(73) Assignees: Ronald Lee, Sindian City (TW); Gino LI, Sindian City (TW)

(21) Appl. No.: 11/311,315

(22) Filed: Dec. 20, 2005

(30) Foreign Application Priority Data
Jul. 21, 2005 (TW) 094124667

(51) Int. Cl. G06Q 10/00

(52) U.S. Cl. 705/5

(57) ABSTRACT

The invention discloses a ticket booking system and method of determining an arrival airport according to a phone number. A ticket booking terminal is used to receive a ticket booking request including phone number information of a destination, and the ticket booking request is transmitted to a ticket booking server via a transmission mechanism. The ticket booking server has a look-up table pre-stored with a country code, an area code and a corresponding airport code of each of a plurality of phone numbers. The ticket booking server finds out a corresponding arrival airport code from the look-up table by comparing the country code and area code of the destination with the look-up table. Finally, the ticket booking server determines an arrival airport according to the found arrival airport code so as to book the flight ticket.

### BACKGROUND OF THE INVENTION

1. Field of the Invention

The present invention relates to a ticket booking system and method and, more practically, to a ticket booking system and method of determining an arrival airport according to a phone number.

2. Description of Related Art

With the rapid growth of societies, it has become popular for people to take business trips or leisure journeys to different countries. In order to provide a convenient service for passengers to purchase flight tickets, the passengers can purchase flight tickets not only directly from the airlines or the travel agency counters, but also via the Internet from other sales points. Take the on-line ticket booking service as an example, both the airlines and the travel agencies run on-line ticket booking websites for providing on-line ticket booking services. All the user has to do is to enter the on-line ticket booking website, and input appropriate data such as ID number, name, departure date, return date, cabin class, departure airport and arrival airport, so as to complete the ticket booking procedure on-line. However, it might be difficult for the user to complete the ticket booking procedure if: the user is not aware of the full name of the arrival airport; the user inputs an incorrect arrival airport name; the user does not realize the arrival airport name even if he/she realizes the location of the destination; there is no airport located at the destination, thereby the user has to find out a correct airport name first, or search for the nearest airport and its name, and then the user can process the ticket booking procedure. Therefore, it is desirable to provide a better ticket booking mechanism to allow the user to complete the ticket booking procedure in a more convenient and accurate way so as to mitigate and/or obviate the aforementioned problems.

### SUMMARY OF THE INVENTION

The present invention relates to a ticket booking system and method. The ticket booking system comprises a ticket booking terminal, a ticket booking server and a transmission mechanism. The ticket booking terminal receives a ticket booking request for purchasing a flight ticket. The ticket booking request includes phone number information of a destination. The ticket booking server processes a ticket booking procedure for the flight ticket. The ticket booking server has a look-up table of phone numbers and corresponding airport codes. The look-up table is pre-stored with a country code, an area code and a corresponding airport code of each phone number. The transmission mechanism is used for transmitting the ticket booking request to the ticket booking server for processing the ticket booking procedure. The ticket booking server finds out a corresponding airport code from the look-up table according to the phone number information of the destination of the ticket booking request, so as to determine an arrival airport for the flight ticket according to the found airport code.

The above ticket booking method comprises the steps of: (A) inputting a ticket booking request from the ticket booking terminal, the ticket booking request including phone number information of a destination; (B) the ticket booking server retrieving a country code and an area code from the phone number information of the destination; (C) the ticket booking server finding out a corresponding arrival airport code from the look-up table by comparing the country code and the area code of the destination with the look-up table; and (D) the ticket booking server determining an arrival airport according to the found arrival airport code so as to book the flight ticket.

Consequently, the above ticket booking system and method is capable of searching for the arrival airport coded for booking the flight ticket according to the country code and area code of the phone number information, thereby reducing the time of searching for a correct arrival airport and reducing the error rate of inputting a wrong arrival airport code.

The above ticket booking server can be a computer, a cellular phone, a card machine, a personal digital assistant or the like.

The above transmission mechanism can be a wired connection, a wireless connection, a networked connection, or other equivalent connections.

The above ticket booking request further includes phone number information of an origin, and the ticket booking server further finds out a corresponding airport code from the look-up table according to the phone number information of the origin of the ticket booking request, so as to determine a departure airport for the flight ticket according to the found airport code.

Other objects, advantages, and novel features of the invention will become more apparent from the following detailed description when taken in conjunction with the accompanying drawings.

### BRIEF DESCRIPTION OF THE DRAWINGS

FIG. 1 illustrates a system structure of one preferred embodiment according to the present invention;

FIG. 2 depicts a flowchart of the preferred embodiment according to the present invention; and

FIG. 3 is an exemplary view of a look-up table showing phone numbers and their corresponding airport codes.

### DETAILED DESCRIPTION OF THE PREFERRED EMBODIMENT

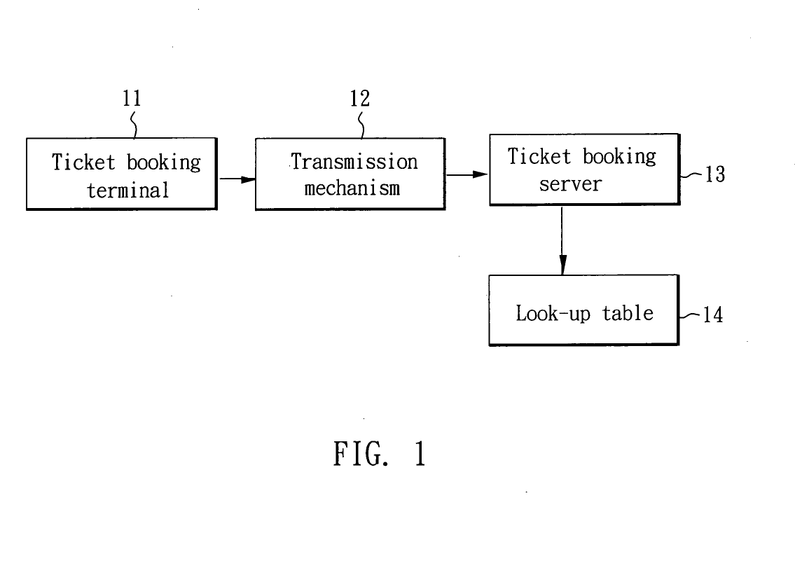

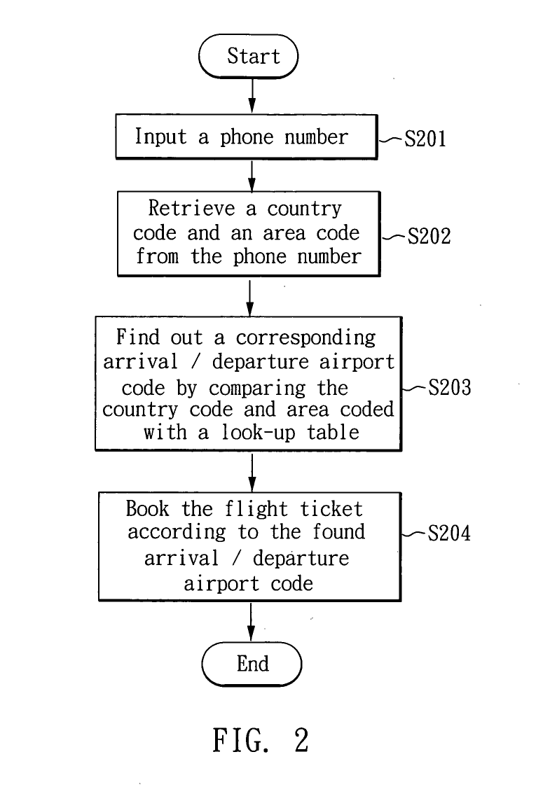

Please refer to FIGS. 1 and 2. FIG. 1 illustrates a system structure, and FIG. 2 depicts a flowchart of the preferred embodiment according to the present invention. In the system structure of FIG. 1, a ticket booking terminal 11 is used for receiving a ticket booking request inputted by a user, and then the ticket booking requested is transmitted to a ticket booking server 13 for purchasing a flight ticket via a transmission mechanism 12. Generally, the user would know the phone number information of the desired destination, such as the phone number of a company or a relative. Therefore, the ticket booking system and method of the present invention just utilizes such phone number information to facilitate the ticket booking procedure. In this embodiment, the ticket booking request includes phone number information of a destination. The ticket booking terminal 11 can be a computer, a cellular phone, a personal digital assistant, a card machine, or other equivalent terminals. The above ticket booking server 12 further has a look-up table 14 stored with phone numbers and their corresponding airport codes. This look-up table 14 is pre-stored with a country code, an area code and a corresponding airport code of each phone number, wherein the airport code refers to an airport located within or nearest the country code and area code of the phone number.

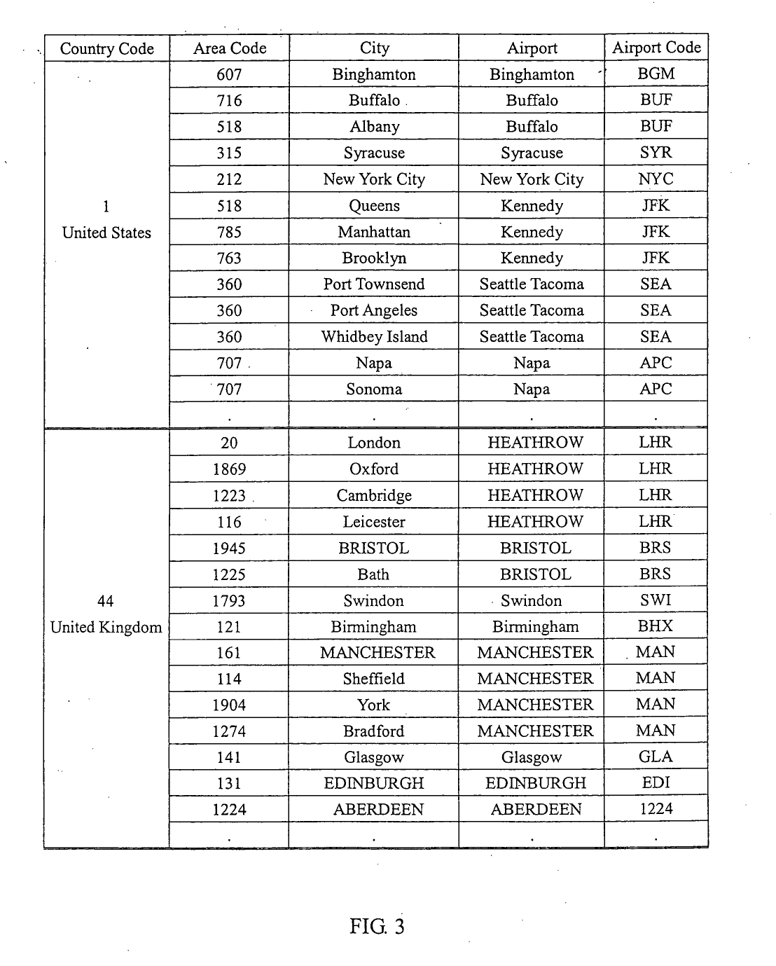

Please also refer to FIG. 2 illustrating the flowchart of this embodiment. When a user wants to purchase a flight ticket, he/she inputs relevant ticket booking data including the phone number information of the destination into the ticket booking terminal 11 so as to generate a ticket booking request (S201). The ticket booking request certainly includes the information of passenger data, the departure airport and the airline name. Please note that the information of the departure airport can also be the phone number information of the origin. Then, the ticket booking terminal 11 transmits this ticket booking request to the ticket booking server 13 via the transmission mechanism 12, so as to process the ticket booking procedure. The transmission mechanism 12 can be, but is not limited to, a wired connection, a wireless connection or a networked connection. After receiving the ticket booking request, the ticket booking server 13 retrieves the country code and the area code from the phone number information of the destination from the ticket booking request (S202). In this embodiment, the ticket booking server 13 is a global allocation system, and it has a look-up table 14 stored with phone numbers and their corresponding airport codes. This look-up table 14 is pre-stored with a country code, an area code and a corresponding airport code of each phone number as shown in the exemplary view of FIG. 3. Next, the ticket booking server 13 finds out a corresponding departure airport code and a corresponding arrival airport code from the look-up table 14 by comparing the country codes and the area codes of the origin and the destination with the look-up table 14 (S203). Finally, the ticket booking server 13 determines a departure airport and an arrival airport according to the found departure airport code and the arrival airport code so as to book the flight ticket (S204).

Please refer to the following examples for a more detailed explanation of the present invention:

### EXAMPLE 1

The user inputs a ticket booking request via the ticket booking terminal 11, wherein the ticket booking request includes phone number information (i.e. 441904) of the destination (i.e. York, UK) (S201). Then, the ticket booking terminal 11 transmits this ticket booking request to the ticket booking server 13 via the transmission mechanism 12, so as to book the flight ticket. Next, the ticket booking server 13 receives the ticket booking request and retrieves the country code (i.e. 44) and area code (i.e. 1904) from the phone number information (i.e. 441904) of the destination (S202). The ticket booking server 13 finds out a corresponding arrival airport code (i.e. MAN) from the look-up table 14 as shown in FIG. 3 by comparing the country code (i.e. 44) and area code (i.e. 1904) of the phone number information (i.e. 441904) with the look-up table 14 (S203). Please note that because there is no airport located at York, what is stored in the look-up table 14 is the nearest airport, Manchester Airport, UK, so as to reduce the user's effort in searching for an appropriate neighboring airport. Finally, the ticket booking server 13 determines the arrival airport (i.e. Manchester Airport) according to the found arrival airport code (i.e. MAN) so as to book the flight ticket (S204).

### EXAMPLE 2

The user inputs a ticket booking request via the ticket booking terminal 11, wherein the ticket booking request includes phone number information (i.e. 441223 and 1360) of the destination (i.e. Cambridge, UK) and the origin (i.e. Port Townsend, USA) (S201). Then, the ticket booking terminal 11 transmits this ticket booking request to the ticket booking server 13 via the transmission mechanism 12, so as to book the flight ticket. Next, the ticket booking server 13 receives the ticket booking request and retrieves the country codes (i.e. 44 and 1) and area codes (i.e. 1223 and 360) of the phone number information (i.e. 441223 and 1360) of the destination and origin (S202). The ticket booking server finds out the corresponding arrival and departure airport codes (i.e. LHR and SEA) from the look-up table 14 as shown in FIG. 3 by comparing the country codes (i.e. 44 and 1) and area codes (i.e. 1223 and 360) of the phone number information (i.e. 441223 and 1360) with the look-up table 14 (S203). Finally, the ticket booking server 13 determines the arrival airport (i.e. Heathrow Airport) and the departure airport (i.e. Seattle Tacoma Airport) according to the found arrival and departure airport codes (i.e. LHR and SEA) so as to book the flight ticket (S204).

According to the above description, the present invention is capable of searching for the arrival (or departure) airport code by utilizing the country code and area code of the phone number information. As a result, when booking a flight ticket, the user only needs to input the country code and area code of the destination (or origin) via the ticket booking terminal 11, and then the inputted message is transmitted via the transmission mechanism 12 to the ticket booking server 13. Next, the ticket booking server 13 would find out a corresponding or neighbor arrival (or departure) airport code by comparing the inputted country code and area code with the look-up table, so as to book the flight ticket, thereby reducing the time of searching for a correct arrival (or departure) airport and reducing the error rate of inputting a wrong arrival (or departure) airport code.

Although the present invention has been explained in relation to its preferred embodiment, it is to be understood that many other possible modifications and variations can be made without departing from the spirit and scope of the invention as hereinafter claimed.

What is claimed is:

1. A ticket booking system of determining an arrival airport according to a phone number, comprising:
a ticket booking terminal for receiving a ticket booking request for purchasing a flight ticket, the ticket booking request including phone number information of a destination;
a ticket booking server for processing a ticket booking procedure for the flight ticket, the ticket booking server having a look-up table of phone numbers and corresponding airport codes, the look-up table pre-stored with a country code, an area code and a corresponding airport code of each phone number; and
a transmission mechanism for transmitting the ticket booking request to the ticket booking server for processing the ticket booking procedure;
wherein the ticket booking server finds out a corresponding airport code from the look-up table according the phone number information of the destination of the ticket booking request, so as to determine an arrival airport for the flight ticket according to the found airport code.

2. The ticket booking system as claimed in claim 1, wherein the ticket booking terminal is a computer, a cellular phone, a card machine or a personal digital assistant.

3. The ticket booking system as claim in claim 1, wherein the transmission mechanism is a wired connection, a wireless connection or a networked connection.

4. The ticket booking system as claimed in claim 1, wherein the ticket booking request further includes phone number information of an origin, and the ticket booking server further finds out a corresponding airport code from the look-up table according to the phone number information of the origin of the ticket booking request, so as to determine a departure airport for the flight ticket according to the found airport code.

5. The ticket booking system as claimed in claim 1, wherein the ticket booking server is a global allocation system.

6. A ticket booking method of determining an arrival airport according to a phone number for allowing a user at a ticket booking terminal to book a flight ticket from a ticket booking server, the ticket booking server having a look-up table of phone numbers and corresponding airport codes, the look-up table pre-stored with a country code, an area code and a corresponding airport code of each phone number; the ticket booking method comprising the steps of:
(A) inputting a ticket booking request from the ticket booking terminal, the ticket booking request including phone number information of a destination;
(B) the ticket booking server retrieving a country code and an area code from the phone number information of the destination;
(C) the ticket booking server finding out a corresponding arrival airport code from the look-up table by comparing the country code and the area code of the destination with the look-up table; and
(D) the ticket booking server determining an arrival airport according to the found arrival airport code so as to book the flight ticket.

7. The ticket booking method as claimed in claim 6, wherein in step (A), the ticket booking request further includes phone number information of an origin; in step (B), the ticket booking server further retrieves a country code and an area code from the phone number information of the origin; in step (C), the ticket booking server further finds out a corresponding departure airport code from the look-up table by comparing the country code and the area code of the destination with the look-up table; and in step (D), the ticket booking server further determines a departure airport according to the found departure airport code so as to book the flight ticket.
